(19) United States
(12) Patent Application Publication
(10) Pub. No.: US 2003/0221102 A1
(43) Pub. Date: Nov. 27, 2003

(54) Method and apparatus for performing multi-server threshold password-authenticated key exchange

(76) Inventors: Bjorn Markus Jakobsson, Hoboken, NJ (US); Philip D. MacKenzie, Maplewood, NJ (US); Thomas E. Shrimpton, Davis, CA (US)

Correspondence Address: Lucent Technologies Inc., Docket Administrator (Room 3J-219), 101 Crawfords Corner Road, Holmdel, NJ, 07733-3030, US

(21) Appl. No.: 10/154,663

(22) Filed: May 24, 2002

(51) Int. Cl. H04L 9/00

(52) U.S. Cl. 713/171

(57) ABSTRACT

A provably secure multi-server threshold password-authenticated key exchange system and method. Initially, an encryption of a function of a client's password is provided to each of a plurality of servers. The client later can authenticate the password (i.e., login) by generating an encryption based on the password which is nonetheless mathematically independent of the value of the password. Then, this encryption, along with a “proof” that the encryption was, in fact, generated based on the password, is provided to each of the servers for verification. Thus, it can be shown that the protocol is provably secure. The password authentication protocol advantageously incorporates a thresholding scheme such that the compromise of fewer than a given threshold number of the servers neither compromises the security of the system nor inhibits the proper operation of the password authentication process.

### CROSS-REFERENCE TO RELATED APPLICATION

The subject matter of this application is related to the subject matter of the U.S. patent application of B. Jakobsson and P. MacKenzie entitled “Method and Apparatus for Distributing Shares of a Password for Use in Multi-Server Password Authentication,” Ser. No. ______, filed on even date herewith and commonly assigned to the assignee of the present invention.

### FIELD OF THE INVENTION

The present invention relates generally to techniques for providing network authentication and key exchange and, more particularly, to a method and apparatus for performing password-authenticated key exchange using a plurality of servers in which a certain threshold of servers participates in user authentication.

### BACKGROUND OF THE INVENTION

Many real-world systems today rely on password authentication to verify the identity of a user before allowing that user to perform certain functions, such as setting up a virtual private network or downloading secret information. There are many security concerns associated with password authentication, due to the fact that the leakage of information to unscrupulous eavesdroppers can compromise the process, potentially resulting in drastic consequences.

When password authentication is performed over a network, one must be especially careful not to allow any leakage of information to one listening in, or even actively attacking, the network. Authentication over a network is an important part of security for systems that allow remote clients to access network servers, and is generally accomplished by verifying one or more of the following:

(i) something a user knows, e.g. a password;

(ii) something a user is, i.e., biometric information, such as a fingerprint; and

(iii) something a user has, i.e., some identification token, such as a smart-card.

For example, an automatic teller machine (ATM) verifies two of these: something a user has, the ATM card, and something a user knows, a personal identification number (PIN). ATM authentication is significantly easier than authentication over a data network because the ATM itself is considered trusted hardware, such that it is trusted to verify the presence of the ATM card and to transfer the correct information securely to a central transaction server.

In addition to authentication, key exchange is an important part of communication across a data network. Once a client and server have been authenticated, a secure communication channel must be set up between them. This is generally accomplished by the client and server exchanging a key, called a session key, for use during communication subsequent to authentication.

Authentication over a data network, especially a public data network like the Internet, is difficult because the communication between the client and server is susceptible to many different types of attacks. For example, in an eavesdropping attack, an adversary may learn secret information by intercepting communication between the client and the server. If the adversary learns password information, the adversary may replay that information to the server to impersonate the legitimate client in what is called a replay attack. Replay attacks are effective even if the password sent from the client is encrypted because the adversary does not need to know the actual password, but instead must provide something to the server that the server expects from the legitimate client (in this case, an encrypted password). Another type of attack is a spoofing attack, in which an adversary impersonates the server, so that the client believes that it is communicating with the legitimate server, but instead is actually communicating with the adversary. In such an attack, the client may provide sensitive information to the adversary.

Further, in any password-based authentication protocol, there exists the possibility that passwords will be weak such that they are susceptible to dictionary attacks. A dictionary attack is a brute force attack on a password that is performed by testing a large number of likely passwords (e.g., all the words in an English dictionary) against some known information about the desired password. The known information may be publicly available or may have been obtained by the adversary through one of the above-described techniques. Dictionary attacks are often effective because users often choose easily remembered, and easily guessed, passwords. Thus, a network authentication technique should have the following property with respect to an active attacker or adversary (i.e., one that may eavesdrop on, insert, delete, or modify messages on a network) who iteratively guesses passwords and runs the authentication protocol: the probability of such an attacker successfully impersonating a user is no better (or at most negligibly better) than it would be if the adversary engaged in a simple on-line guessing attack.

There are various known techniques for network authentication. Some of these techniques require the client to store the public key of the authentication server, including those where the protocol consists of sending a password over a previously secured web connection, such as is done in the well-known TLS Protocol standard (fully familiar to those of ordinary skill in the art), or in the Halevi-Krawczyk protocol, described in S. Halevi and H. Krawczyk, “Public-Key Cryptography and Password Protocols,” 5th ACM Conference on Computer and Communications Security, pp. 122-131, 1998, whose disclosure is incorporated by reference herein. (Note that the Halevi-Krawczyk protocol is provably secure against the type of attacker described above.)

Other techniques do not require the client to store a public key of the authentication server. These include, for example, those described in D. Jablon, Strong Password-Only Authenticated Key Exchange, ACM Computer Communication Review, ACM SIGCOMM, 26(5):5-20, 1996, and in T. Wu, The Secure Remote Password Protocol, 1998 Internet Society Symposium on Network and Distributed System Security, 1998, the disclosures of which are incorporated by reference herein. In addition, the following references also describe such protocols, and moreover, each of these protocols has been proven to be secure against the attacker described above: M. Bellare, D. Pointcheval, and P. Rogaway, Authenticated Key Exchange Secure Against Dictionary Attacks, Eurocrypt 2000, pp. 139-155, 2000 (hereinafter, “Bellare et al.”); commonly assigned U.S. patent application identified by Ser. No. 09/353,468, filed on Jul. 13, 1999 in the name of P. MacKenzie et al. and entitled “Secure Mutual Network Authentication Protocol (SNAPI)”; commonly assigned U.S. patent application identified by Ser. No. 09/638,320, filed on Aug. 14, 2000 in the name of V.V. Boyko et al. and entitled “Secure Mutual Network Authentication and Key Exchange Protocol”; commonly assigned U.S. patent application identified by Ser. No. 09/827,227, filed on Apr. 5, 2001 in the name of P. MacKenzie and entitled “Methods And Apparatus For Providing Efficient Password-Authenticated Key Exchange”; J. Katz, R. Ostrovsky and M. Yung, Efficient Password-Authenticated Key Exchange Using Human-Memorable Passwords, Cryptology Eprint Archive, http://eprint.iacr.org/2001/031, 2001 (expanded version of J. Katz, R. Ostrovsky and M. Yung, Practical Password-Authenticated Key Exchange Provably Secure Under Standard Assumptions, Eurocrypt 2001, pp. 475-494, 2001); and 0. Goldreich and Y. Lindell, Session-Key Generation Using Human Passwords Only, CRYPTO 2001, pp. 408-432, 2001. The disclosures of each of these references is also incorporated by reference herein.

However, all of these protocols, even the ones in which the server's public key is known to the user, are vulnerable to server compromise in the sense that compromising the server would allow an attacker to obtain the password verification data on that server (typically some type of one-way function of the password and some public values). This could then be used to perform an offline dictionary attack on the password. To address this issue (without resorting to assumptions such as, for example, tamper resistance), in W. Ford and B. S. Kaliski, Jr., Server-Assisted Generation of a Strong Secret from a Password, Proceedings of the 5th IEEE International Workshop on Enterprise Security, 2000 (hereinafter, “Ford and Kaliski”), the disclosure of which is incorporated by reference herein, it was suggested that the functionality of the server be distributed, thereby forcing an attacker to compromise multiple servers in order to be able to obtain password verification data. (As is well-known in the practice of distributed cryptography, for high security one should be careful to ensure that it is not easy for an attacker to compromise several servers with the same attack, which may be the case, for example, if they are all running the same operating system.) Note that the main problem in such an approach is not merely to distribute the password verification data, but to distribute the functionality, i.e., to distribute the password verification data such that it can be used for authentication without ever reconstructing the data on any one or more (but less than all) of the required servers.

While multiple party cryptosystems have been studied extensively (and many proven secure) for other cryptographic operations, such as signatures (see, e.g., Y. Desmedt and Y. Frankel, Threshold Cryptosystems, CRYPTO 1989, pp. 307-315, 1989, the disclosure of which is incorporated by reference herein), multi-server password-authenticated key exchange systems have no such history prior to the system disclosed in Ford and Kaliski. In D. Jablon, Password Authentication Using Multiple Servers, RSA Conference 2001, Cryptographers' Track, pp. 344-360, 2001 (hereinafter “Jablon”), the disclosure of which is also incorporated by reference herein, the system of Ford and Kaliski is extended, most notably so as not to require the server's public key to be known to the user.

However, neither the protocol of Ford and Kaliski nor the protocol of Jablon have been proven secure. Moreover, each of these prior art multi-server password authentication systems require the participation of each and every one of the servers in order to authenticate a client's password. While this makes it likely that the compromise of less than all of the servers will fail to compromise the client's password, it also fails to allow password authentication from taking place at all when any of the servers are unavailable (for whatever reason).

### SUMMARY OF THE INVENTION

In accordance with certain illustrative embodiments of the present invention, a provably secure multi-server threshold password-authenticated key exchange system and method is provided. In particular, an illustrative protocol in accordance with the present invention includes a client—having a password to be authenticated by a plurality of servers—generating an encryption based on the password which is nonetheless mathematically independent of the value of the password. Then, this encryption, along with a “proof” that the encryption was, in fact, generated based on the password, is provided to each of the servers for verification. In this manner, it can be shown that the protocol in accordance with the illustrative embodiment of the present invention is provably secure.

In accordance with one illustrative embodiment of the invention, an encryption of a function of the client's password is initially provided to each of a plurality of servers. Then, the password authentication protocol in accordance with this illustrative embodiment of the present invention advantageously incorporates a thresholding scheme such that the compromise of fewer than a given threshold number of the servers neither compromises the security of the system nor inhibits the proper operation of the password authentication process.

### BRIEF DESCRIPTION OF THE DRAWINGS

FIG. 1 shows the operation of an illustrative server setup phase in accordance with one illustrative embodiment of the present invention.

FIG. 2 shows the operation of an illustrative client setup phase in accordance with one illustrative embodiment of the present invention.

FIG. 3 shows the operation of the client activity associated with an illustrative client login protocol phase in accordance with one illustrative embodiment of the present invention.

FIG. 4 shows the operation of the server activity associated with an illustrative client login protocol phase in accordance with one illustrative embodiment of the present invention.

FIG. 5 shows the detailed operation of the illustrative client login protocol in accordance with the illustrative embodiment of the present invention shown in FIGS. 3 and 4.

FIG. 6 shows the detailed operation of the function Prove_{Φ}_{_{Q}} in accordance with the illustrative client login protocol of the present invention shown in FIG. 5.

FIG. 7 shows the detailed operation of the function Verify_{Φ}_{_{Q}} in accordance with the illustrative client login protocol of the present invention shown in FIG. 5.

FIG. 8 shows the detailed operation of the function DistVerify in accordance with the illustrative client login protocol of the present invention shown in FIG. 5.

FIG. 9 shows the detailed operation of the function Prove₁₀₀ _{_{R}} in accordance with the illustrative client login protocol of the present invention shown in FIG. 5.

FIG. 10 shows the detailed operation of the function Verify_{Φ}_{_{R}} in accordance with the illustrative client login protocol of the present invention shown in FIG. 5.

FIG. 11 shows the detailed operation of the function Prove_{Φ}_{_{S}} in accordance with the illustrative client login protocol of the present invention shown in FIG. 5.

FIG. 12 shows the detailed operation of the function Verify_{Φ}_{_{S}} in accordance with the illustrative client login protocol of the present invention shown in FIG. 5.

FIG. 13 shows the detailed operation of the function Prove_{Φ}_{_{T}} in accordance with the illustrative client login protocol of the present invention shown in FIG. 5.

FIG. 14 shows the detailed operation of the function Verify_{Φ}_{_{T}} in accordance with the illustrative client login protocol of the present invention shown in FIG. 5.

FIG. 15 shows a generalized hardware architecture of a data network and computer systems suitable for implementing a multi-server threshold password-authenticated key exchange system in accordance with an illustrative embodiment of the present invention.

### DETAILED DESCRIPTION

Overview

In accordance with an illustrative embodiment of the present invention, a multi-server threshold password-authenticated key exchange system is advantageously achieved by storing a semantically-secure encryption of a function of the password at the servers (instead of simply storing a one-way function of the password, as is typical in prior art systems), and then leveraging off well known solutions for distributing secret decryption keys, such as, for example, the Feldman verifiable secret sharing technique, familiar to those skilled in the art and described in P. Feldman, A Practical Scheme for Non-Interactive Verifiable Secret Sharing, 28th IEEE Symposium on Foundations of Computer Science, pp. 427-437, 1987 (hereinafter, “Feldman”). In other words, the problem of distributing password authentication information is advantageously transformed to the problem of distributing cryptographic keys. (In accordance with certain illustrative embodiments of the present invention, the cryptographic protocol used is based on the well known Diffie-Hellman protocol. See, for example, U.S. Pat. No. 4,200,770, entitled “Cryptographic Apparatus and Method,” issued on Sep. 6, 1977 to M. Hellman et al. U.S. Pat. No. 4,200,770 is incorporated by reference herein.)

However, once this transformation is made, verifying passwords without leaking information becomes much more complex. Specifically, in accordance with one illustrative embodiment of the present invention, intricate manipulations of ElGamal encryptions and careful use of efficient non-interactive zero-knowledge proofs, each of which are familiar to those skilled in the art, are advantageously employed. See, e.g., T. ElGamal, A Public Key Cryptosystem and a Signature Scheme Based on Discrete Logarithm, IEEE Transactions on Information Theory, 31:469-472, 1985 (hereinafter “ElGamal”), and M. Blum, A. DeSantis, S. Micali and G. Persiano, Noninteractive Zero-Knowledge, Siam Journal on Computing, Vol. 20, No. 6, pp. 1084-1118, December, 1991 (hereinafter “Blum et al.”), respectively, each of which is incorporate by reference herein.

Model

Specifically, the following description of an illustrative embodiment of the present invention is based on the model detailed in Bellare et al. This model was specifically designed for the problem of authenticated key exchange (“ake”) between two parties, a client and a server. The purpose of the model is to enable the two parties to engage in a protocol such that after the protocol was completed, they would each hold a session key that is known only to the two of them.

Similarly, in accordance with the principles of the present invention, a model is advantageously designed for the problem of distributed authenticated key exchange (“dake”) between a client and a plural number k of servers. In this case, the purpose of the model is to enable the parties to engage in a protocol such that after the protocol is completed, the client would advantageously hold k session keys, each one being shared with (a different) one of the k servers, such that the session key shared between the client and a given server is known only to the client and that particular server, even if up to k−1 other servers were to conspire together.

Note that a secure dake protocol allows for secure downloadable credentials, by, e.g., having the servers store an encrypted credentials file with a decryption key stored using a threshold scheme among them, and then having each send a partial decryption of the credentials file to the client, encrypted with the session key it shares with the client. Note that the credentials are secure in a threshold sense—that is, fewer than the given threshold of servers are unable to obtain the credentials.

In accordance with the principles of the invention, there are two types of protocol participants—clients and servers. Define ID=Clients U Servers such that ID is a non-empty set of protocol participants, or “principals.” Assume Servers consists of n servers, denoted {S₁, . . . , Sₙ}, and that these servers are intended to cooperate in authenticating a client. (Note that it will be obvious to one of ordinary skill in the art how the instant model could be extended to have multiple sets of servers, but for clarity of presentation such a generalization will not be described herein.) Each client C ε Clients has a secret password π_{C}, and each server S ε Servers has a vector π_{S}=[π_{S}[C]]_{CεClients}. Entry π_{S}[C] is referred to herein as the “password record.” Let Password_{C} be a (possibly small) set from which passwords for client C are selected. Assume that

$${π}_{c} {←}^{ R } {Password}_{c} ,$$

although it will be obvious to those of ordinary skill in the art that the following may be easily extended to other password distributions. Clients and servers may be advantageously modeled as probabilistic polynomial-time algorithms with an input tape and an output tape.

Definitions

Let k be the cryptographic security parameter. Let G_{q} ε E G denote a finite (cyclic) group of order q, where |q|=k. Let g be a generator of G_{q}, and assume it is included in the description of G_{q}.

Now use (a,b)×(c,d) to mean element-wise multiplication, i.e., (ac,bd), and use (a,b)^{r} to mean element-wise exponentiation, i.e., (a^{r},b^{r}). For a tuple V, the notation V[j] means the j'th element of V.

Now denote by Σ the set of all functions H from {0,1}* to {0,1}^{∞}. This set is provided with a probability measure by saying that a random H from Σ assigns to each xε{0,1}* a sequence of bits each of which is selected uniformly at random. As is well known to those skilled in the art, this sequence of bits may be used to define the output of H in a specific set, and thus it may be assumed that one can specify that the output of a random oracle H be interpreted as a (random) element of G_{q}. (Note, for example, that this can be easily defined when G_{q} is a q-order subgroup of Z*ₚ, where q and p are prime.) Access to any public random oracle H ε Ω is given to all algorithms; specifically, it is given to the protocol P and to the adversary (i.e., it is public). Assume that secret session keys are drawn from {0,1}^{k}.

An Illustrative Protocol in Accordance with the Present Invention

The following describes in detail a protocol for threshold password-authenticated key exchange in accordance with an illustrative embodiment of the present invention. The illustrative protocol in its entirety consists of three separate phases:

(A) a server setup phase, in which each of the multiple servers generate appropriate cryptographic keys for use by the client;

(B) a client setup phase, in which the client creates a ciphertext encryption based on the password and transmits it to each of the servers; and

(C) the client login protocol phase—which itself comprises both client activity and server activity—in which the client's password is submitted to the servers for authentication and authenticated by the servers.

Each of these phases will be described in detail below.

An Illustrative Server Setup Phase According to one Embodiment of the Invention

Assume that there are n servers {Sₗ}_{lε{1,2, . . . , n}}. Let (x,y) be the servers' “global” key pair such that y=g^{x}. In accordance with the principles of the present invention and according to one illustrative embodiment of the present invention, the servers advantageously share the global secret key x using a (k,n)-threshold Feldman secret sharing protocol, fully familiar to those of ordinary skill in the art. (See, e.g., Feldman, cited above.) Specifically, a polynomial f(z)=Σⱼ₌₀^{k-1}aⱼz^{j} mod q is chosen with a₀←x and random coefficients

$${a}_{j} {←}^{ R } {Z}_{q} for j > 0.$$

for j>0. Then each server Sᵢ gets a secret share xₗ=f (i) and a corresponding public share yₗ=g^{x}^{ₗ}, 1≦i≦n. (It will be assumed herein that a trusted dealer generates these shares, but it will be obvious to those skilled in the art that it is also possible to have the servers generate them using, for example, a distributed protocol.) In addition, each server Sᵢ independently generates its own “local” key pair (xₗ′, yₗ′) such that yₗ′=g^{x}^{ₗ}^{′}, 1≦i≦n. Each server Sᵢ then publishes its “local public key” yᵢ′ along with its share of the global public key yᵢ. Also, let H₀,H₁,H₂,H₃,H₄,H₅,H₆

$${H}_{6} {←}^{ R } Ω$$

be random oracles with domain and range defined by the context of their use. Let h←H₀(y) and h′←H₁(y) be generators for G_{q}. (H₂ through H₆ will be used below.)

Note that in accordance with the illustrative embodiment of the present invention described herein, the servers are assumed to have (securely) stored the 2n+1 public values y, {yᵢ′}ᵢ₌₁ⁿ, and {yₗ}ₗ₌₁ⁿ. Likewise, the client is assumed herein to have (securely) stored the n+1 public values y and {yᵢ′}ᵢ₌₁ⁿ. However, in accordance with other illustrative embodiments of the present invention, a trusted certification authority (CA) could certify these values. The details of such an alternative approach will be obvious to those of ordinary skill in the art.

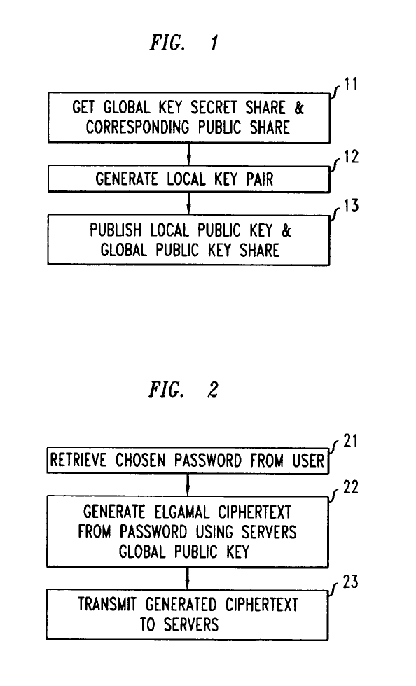

FIG. 1 shows the operation of an illustrative server setup phase in accordance with one illustrative embodiment of the present invention. As shown in the figure, block 11 gets the global key secret share (xᵢ) and the corresponding public share (yᵢ) for the given server (i); block 12 generates the local key pair (xₗ′, yₗ′); and block 13 publishes the local public key (yᵢ′) and its global public key share (yᵢ).

An Illustrative Client Setup Phase According to One Embodiment of the Invention

Assume that a client Cε Clients has a secret password π_{C} drawn from a set Password_{C}. It may be further assumed herein that Password_{C} can be mapped into Z_{q}. In accordance with one illustrative embodiment of the present invention, C advantageously creates an ElGamal ciphertext encryption (fully familiar to those skilled in the cryptographic art—see ElGamal, cited above), E_{C} of the value g^{(π}^{_{C}}⁾^{⁻¹}, using the servers' global public key y. More precisely, C randomly selects

$$α {←}^{ R } {Z}_{q}$$

and computes E_{C}<(y^{α}g^{(π}^{_{C}}⁾^{⁻¹}, g^{α}). Then, C sends E_{C} to each of the servers Sᵢ, 1≦i≦n, each of which advantageously records (C, E_{C}) in their database. (In accordance with an alternative illustrative embodiment of the present invention, a trusted Certification Authority (CA) could be used. The additional details of such an embodiment will be obvious to those skilled in the art.)

Note that it is to be assumed herein that any adversary (i.e., attacker) does not observe or participate in either the system or client setup phases. It may also be assumed that the client saves a copy of E_{C}. Alternatively, the client could obtain a copy through interaction with the servers, and if so, it could be certified in some way, either by a trusted CA or by some type of server signatures. Again, the additional details of such an embodiment will be obvious to those skilled in the art.

FIG. 2 shows the operation of an illustrative client setup phase in accordance with one illustrative embodiment of the present invention. As shown in the figure, block 21 retrieves the password that the user chooses; block 22 generates the ElGamal ciphertext encryption (E_{C}) as described above; and block 23 transmits the generated ciphertext encryption to the servers.

An Illustrative Client Login Protocol According to an Embodiment of the Invention

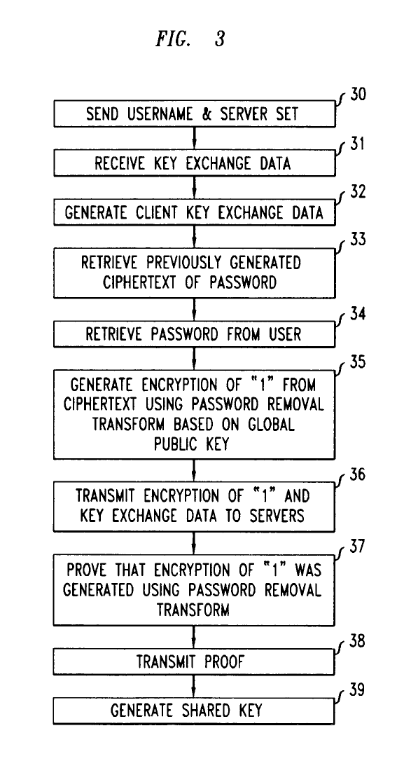

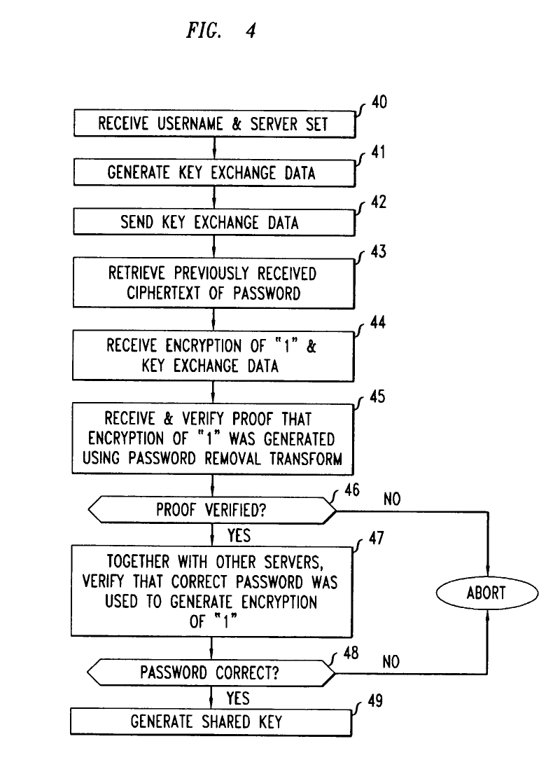

Once the setup phases have been completed in the above described manner, the client is advantageously able to “login” (i.e., submit the password for authentication) in accordance with an illustrative embodiment of the present invention. FIG. 3 shows the operation of the client activity associated with an illustrative client login protocol phase in accordance with one illustrative embodiment of the present invention, and FIG. 4 shows the operation of the server activity associated with an illustrative client login protocol phase in accordance with one illustrative embodiment of the present invention. Each of these figures will be described below.

In particular, the above described illustrative protocol advantageously makes use of a simulation-sound non-interactive zero-knowledge proof (SS-NIZKP) scheme, which schemes are fully familiar to those of ordinary skill in the art, in order to provide the “proof” described above. (See Blum et al., cited above.) More particularly, in accordance with the illustrative embodiment of the present invention, the protocol for a client Cε Clients employs an SS-NIZKP scheme with a “prove” function Prove_{Φ}_{_{Q}} and a “verify” function Verify_{Φ}_{_{Q}}, over a language defined by a predicate Φ_{Q} that takes elements of {0,1}*×(G_{q}×G_{q})³. (The use of “prove” and “verify” functions in connection with an SS-NIZKP is fully familiar to those skilled in the art.) Specifically, the predicate Φ_{Q} is defined as

Φ_{Q}(τ,E_{C},B,V)=∃β,π,γ:(B=(y^{β},g^{β})×(E_{C})^{π}×(g⁻¹, 1)) and (V=(h^{γ}g^{π}, g^{γ})).

The algorithms Prove_{Φ}_{_{Q}} and Verify_{Φ}_{_{Q}} advantageously use a random oracle H₃. Prove_{Φ}_{_{Q}} may be implemented in a conventional manner as a three-move honest-verifier proof made non-interactive by using the hash function to generate the verifier's random challenge, and having τ be an extra input to the hash function. Such an implementation will be obvious to those skilled in the art. (Note that other proof functions which are defined below may be implemented in a similar manner.)

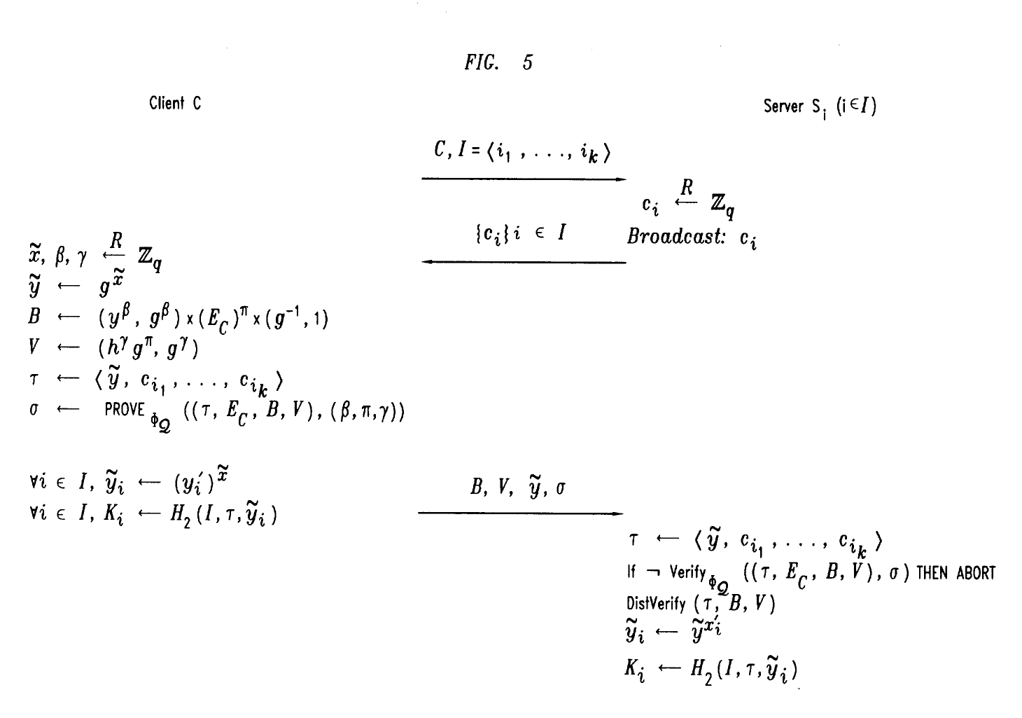

FIG. 5 shows the detailed operation of the illustrative client login protocol in accordance with the illustrative embodiment of the present invention as shown in FIGS. 3 and 4, specifying the detailed operation of both the client and each of the servers in accordance therewith. Specifically, as can be seen in the figure, the client Cε Clients receives a set I of k servers in Servers and initiates the protocol with that set, by broadcasting I along with its own identity C. (Note that aggregation and broadcast functionalities for the communication between the client and the servers, as well as among the servers themselves, are assumed.)

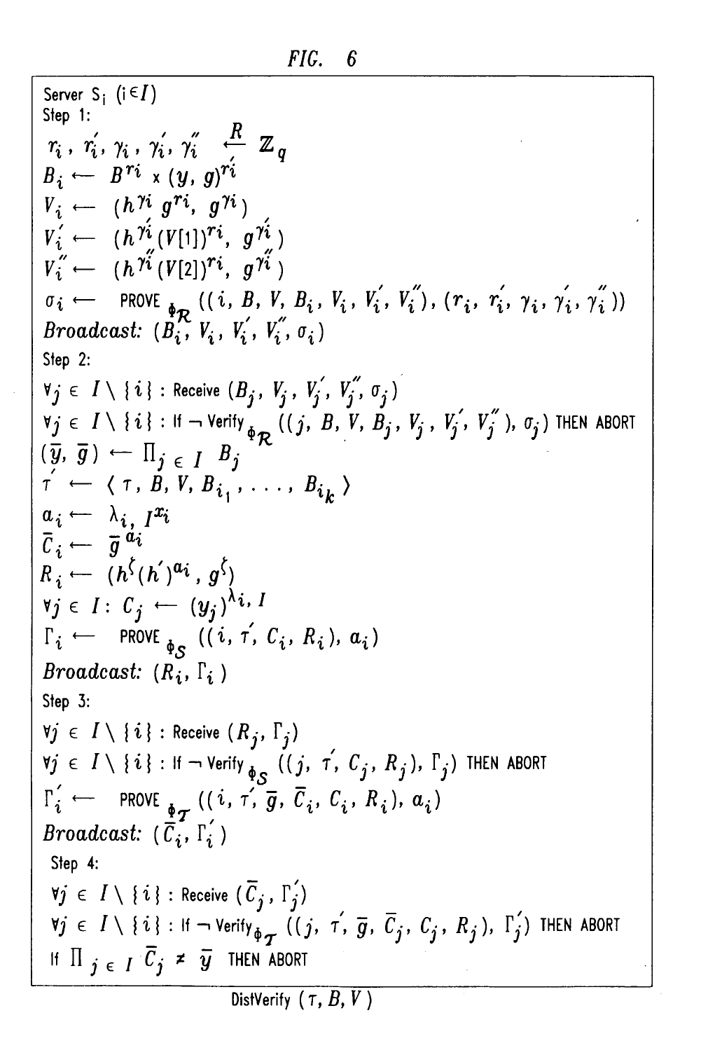

In return, C receives nonces from the servers in I. Then, in accordance with the principles of the present invention, the client advantageously “removes” the password from the ciphertext encryption E_{C} by raising it to π_{C} and dividing g out of the first element of the tuple, and then re-blinds the result to form B. (Note that “removing the password” as used herein means that a mathematical operation is performed such that the result is mathematically independent of the value of the password. Such a procedure will be referred to herein as a “password removal transform.”) The quantity V is then formed to satisfy the predicate Φ_{Q}, and an SS-NIZKP σ is created, with use of the function Prove_{Φ}_{_{Q}}, to bind B,V, the session public key \tilde{y}, and the nonces from the servers (the latter two of which have been combined into τ). This SS-NIZKP also forces the client to behave properly (i.e., in a way that allows a simulator in the proof of security to operate correctly). FIG. 6 shows the detailed operation of the function Prove_{Φ}_{_{Q}} in accordance with the illustrative client login protocol of the present invention shown in FIG. 5.

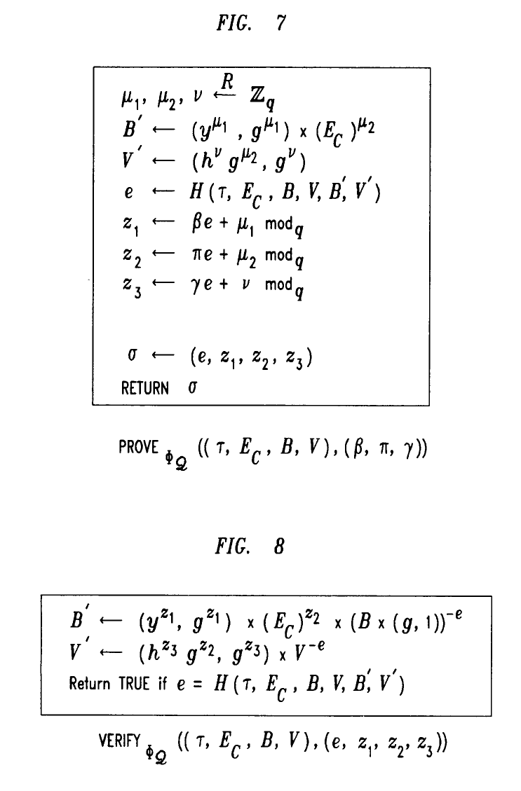

Each of the servers then proceed to verify the SS-NIZKP by executing the function Verify_{Φ}_{_{Q}}. Specifically, this step verifies that σ was in fact generated using the password removal transform. FIG. 7 shows the detailed operation of the function Verify_{Φ}_{_{Q}} in accordance with the illustrative client login protocol of the present invention shown in FIG. 5.

Now, note that if the client has in fact used the password π=π_{C}, it will necessarily be the case that B[1]=γ^{β+απ} and B[2]=g^{β+απ}. Thus, the servers next execute the function DistVerify(r,B,V) to verify that lo_{g}Y=log_{B[2]}B[1]. (See FIG. 8 and the detailed description of DistVerify below.) In effect, this is verifying (without decryption) that B is a valid encryption of the plaintext message “1”. Each server Sᵢ then computes a session key Kᵢ, which has also been computed by the client.

Note that the illustrative protocol as specified does not provide forward security. However, in accordance with another illustrative embodiment of the present invention, forward security may be advantageously achieved by having each server Sᵢ generate its Diffie-Hellman values dynamically, rather than by just using yᵢ′. Then, these values would be advantageously certified by Sᵢ to protect the client against a man-in-the-middle attack. The details will be clear to those skilled in the art.

FIG. 8 shows the detailed operation of the function DistVerify in accordance with the illustrative client login protocol of the present invention shown in FIG. 5. The DistVerify portion of the illustrative protocol in accordance with the illustrative embodiment of the present invention takes three parameters, τ, B, and V, and is executed by the servers {Sₗ}_{lεI} to verify that log_{g}y=log_{B[2]}B[1], i.e., that B is in fact an encryption of “1”. (Note that the parameter V is advantageously included in order to allow a proof of security, and thus may be omitted in other illustrative embodiments of the present invention.) Note that the DistVerify function uses a conventional notation for Lagrange coefficients:

$${λ}_{j , I} = {\prod }_{l ∈ I \backslash \{ j \}}^{} \frac{- l}{j - l} mod q .$$

The DistVerify portion of the illustrative protocol operates as follows. First the servers distributively compute B^{r}, thereby randomizing the quotient B[1]/(B[2])^{x} if it is not equal to 1. Then they take the second component (i.e., (B[2])^{r}) and distributively compute ((B[2])^{r})^{x} using their shared secrets. Finally they verify that ((B[2])^{r})^{x}=(B[1])^{r}), implying that B[1]=(B[2])^{x}, and hence that B is in fact an encryption of 1. The protocol advantageously makes use of three SS-NIZKP schemes as follows:

1. An SS-NIZKP scheme with a “prove” function Prove_{Φ}_{_{R}} and a “verify” function Verify_{Φ}_{_{R}}, over a language defined by a predicate Φ_{R} that takes elements of Z×(G_{q}×G_{q})⁶ and is defined as

Φ_{R}(i,B,V,Bₗ,Vₗ,Vₗ′,Vₗ″)=∃rₗ,rₗ′,γₗ,γₗ′,γₗ″: Bₗ=B^{r}^{ₗ}×(y,h)^{r}^{ₗ}′ and Vᵢ=(h^{γ}^{ₗ}g^{r}^{ₗ},g^{γ}^{ₗ}) and Vₗ′=(h^{γ}^{ₗ}′(V[1])^{r}^{ₗ},g^{γ}^{ₗ}′) and Vₗ″(h^{γ}^{ₗ}″(V[2])^{r}^{ₗ}, g^{γ}^{ₗ}″).

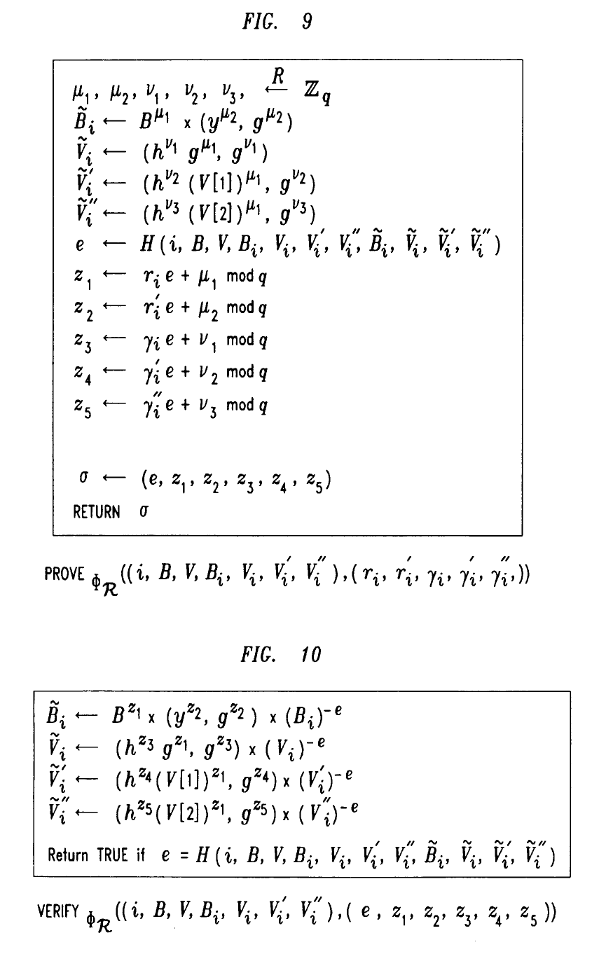

The algorithms Prove_{Φ}_{_{R}} and VerifyΦ_{_{R}} advantageously use a random oracle H₄. FIG. 9 shows the detailed operation of the function Prove_{Φ}_{_{R}}, and FIG. 10 shows the detailed operation of the function Verify_{Φ}_{_{R}}, each in accordance with the illustrative client login protocol of the present invention shown in FIG. 5.

2. An SS-NIZKP scheme with a “prove” function Prove₁₀₁ _{_{S}} and a “verify” function Verify_{Φ}_{_{S}}, over a language defined by a predicate Φ_{S} that takes elements of Z×{0,1}*×G_{q}×(G_{q}×G_{q}) and is defined as

Φ_{S}(i,τ′,Cᵢ,Rᵢ)=∃α,γ: Cᵢ=g^{α} and Rᵢ=(h^{γ}(h′)^{α},g^{γ}).

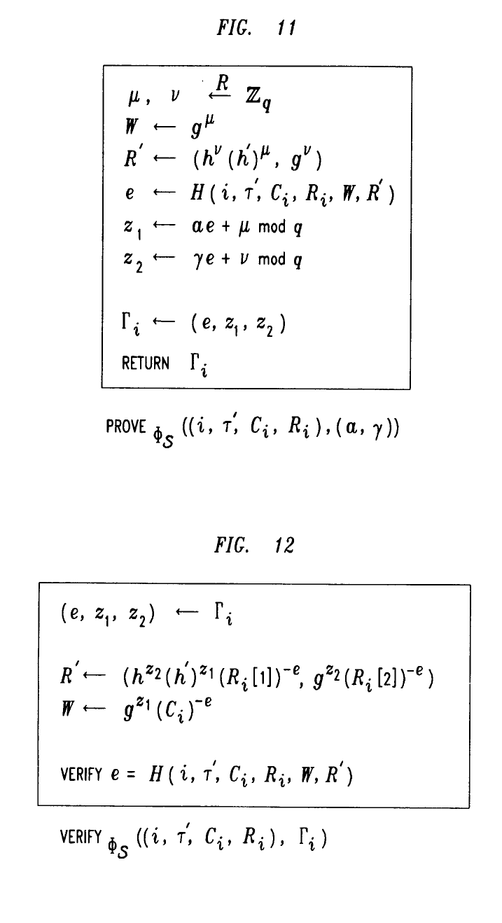

The algorithms Prove_{Φ}_{_{S}} and Verify_{Φ}_{_{S}} advantageously use a random oracle H₅. FIG. 11 shows the detailed operation of the function Prove_{Φ}_{_{S}}, and FIG. 12 shows the detailed operation of the function Verify_{Φ}_{_{S}}, each in accordance with the illustrative client login protocol of the present invention shown in FIG. 5.

3. An SS-NIZKP scheme with a “prove” function Prove_{Φ}_{_{T}} and a “verify” function Verify_{Φ}_{_{T}}, over a language defined by a predicate Φ_{T} that takes elements of Z×{0,1}*×G_{q}×G_{q}×G_{q}×(G_{q}×G_{q}×) and is defined as

Φ_{T}(i,τ′,\overline{g},\overline{C}ₗ,Cₗ,Rₗ)=∃α,γ,: \overline{C}ₗ=\overline{g}^{α} and Cᵢ=g^{α} and Rᵢ=(h^{γ}(h′)^{α},g^{γ}).

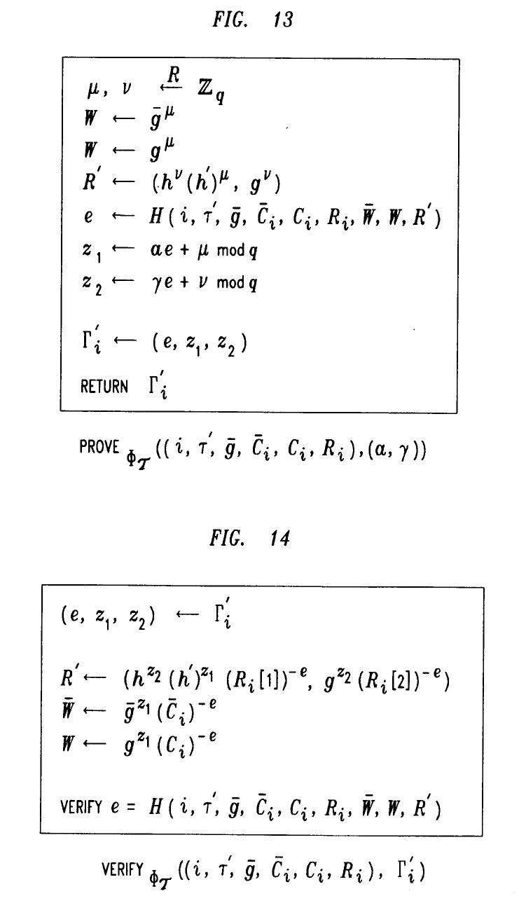

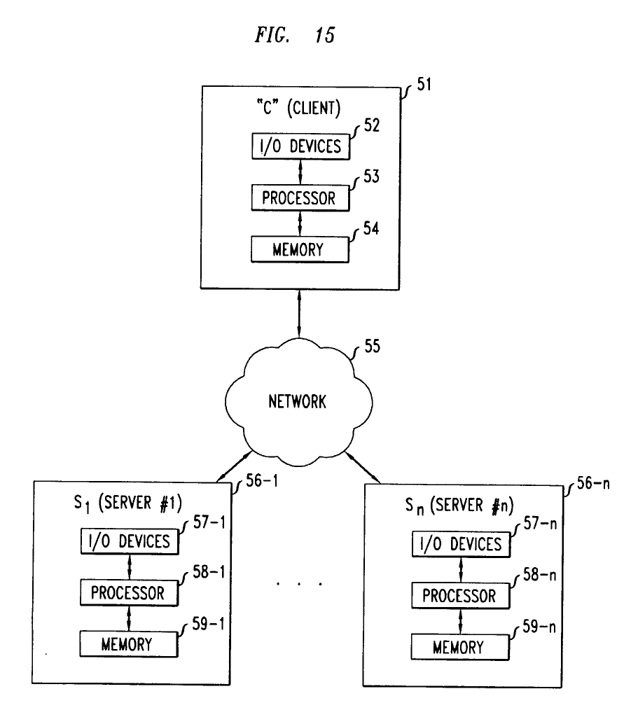

The algorithms Prove_{Φ}_{_{T}} and Verify_{Φ}_{_{T}} advantageously use a random oracle H₆. FIG. 13 shows the detailed operation of the function Prove_{Φ}_{_{T}}, and FIG. 14 shows the detailed operation of the function Verify_{Φ}_{_{T}}, each in accordance with the illustrative client login protocol of the present invention shown in FIG. 5.

Specifically, referring back to FIG. 3, the client activity for the illustrative client login protocol proceeds as follows. As shown in the figure, in block 30, the client sends the username of the client (C) to the servers and also identifies the set of servers (I= [symbol] i₁, . . . iₖ [symbol] ) to each individual server. In block 31, the client receives the key exchange data from the servers and in block 32, generates the client key exchange data. Then, in block 33, the client retrieves the ElGamal ciphertext encryption of the user's password (E_{C}) that was previously generated by the client, and in block 34, retrieves the password itself (π) from the user.

Next, in accordance with an illustrative embodiment of the present invention, in block 35, the client generates, from the ciphertext encryption of the password, an encryption of “1” (B) from the ciphertext encryption using a password removal transform, where the encryption is advantageously based on the global public key. Then, in block 36, the client transmits this encryption of “1” (B) along with the key exchange data to the servers. In block 37, the client generates a “proof” (Prove_{Φ}_{_{Q}}) that the encryption of “1” was, in fact, generated using the password removal transform, and in block 38, the client transmits that proof (asσ) to the servers. Finally, in block 39, the client generates the shared keys (Kᵢ) for communication with each of the servers (assuming, of course, that the authentication of the client succeeds).

Now, referring back to FIG. 4, the server activity for the illustrative client login protocol proceeds as follows. (Note that in accordance with the illustrative embodiment of the present invention, the procedure of FIG. 4 is advantageously performed by each of the multiple servers concurrently.) In block 40, the server receives the username (C) and the identification of the server set (I= [symbol] i₁, . . . iₖ [symbol] ). Then, in block 41, each server generates its key exchange data (cᵢ) and in block 42 transmits that data to the client. And in block 43, the server retrieves the previously received (and stored) ElGamal ciphertext encryption of the password (E_{C}).

Then, in accordance with an illustrative embodiment of the present invention, in block 44 each server receives the encryption of “1” (B) along with the key exchange data as sent by the client. And in block 45, each server receives the proof (σ) sent by the client and then attempts to “verify” the proof (i.e., verify that the encryption was in fact generated with use of the password removal transform) by executing the function Verify_{Φ}_{_{Q}}. If this verification fails (as tested by decision block 46), the password authentication is advantageously aborted. Otherwise, in block 47, the servers jointly operate to verify that the encryption was generated with use of the proper password (i.e., that the encryption is in fact a valid encryption of the plaintext message “1”). If this verification fails (as tested by decision block 48), the password authentication is also advantageously aborted. Otherwise, and finally, in block 49, each of the servers generates the shared keys (Kᵢ) for communication with the client.

An Illustrative Hardware Architecture According to One Illustrative Embodiment

FIG. 15 shows a generalized hardware architecture of a data network and computer systems suitable for implementing a multi-server threshold password-authenticated key exchange system in accordance with an illustrative embodiment of the present invention. The environment shown in the figure includes a client system 51 (which illustratively includes input/output devices 52, processor 53, and memory 54) and a plurality of server systems 56-1 through 56-n (which illustratively include input/output devices 57-1 through 57-n, processors 58-1 through 58-n, and memories 59-1 through 59-n, respectively). The client system and each of the server systems are illustratively interconnected through network 55. In accordance with an illustrative embodiment of the present invention, processor 53 of client system 51 illustratively executes the procedures shown in FIGS. 2 and 3 as described above, while processors 58-1 through 58-n of each of servers 56-1 through 56-n, respectively, illustratively executes the procedures shown in FIGS. 1 and 4 as described above.

Addendum to the Detailed Description

It should be noted that all of the preceding discussion merely illustrates the general principles of the invention. It will be appreciated that those skilled in the art will be able to devise various other arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future—i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

The functions of the various elements shown in the figures, including functional blocks labeled as “processors” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

We claim:

1. A method for performing password authentication between a client and a plurality of servers, the client having a password to be authenticated by the plurality of servers, each of the plurality of servers having a share of a secret key, the secret key having a public key associated therewith, the method performed by the client and comprising the steps of:
generating an encryption using the public key, wherein the generation of the encryption is based on the password, but wherein the generated encryption is mathematically independent of the password; and
communicating the generated encryption to the plurality of servers.

2. The method of claim 1 wherein said encryption is generated based on an ElGamal ciphertext encryption of a function of said password.

3. The method of claim 1 wherein said encryption is a representation of a predetermined plaintext message.

4. The method of claim 3 wherein said predetermined plaintext message is “1”.

5. The method of claim 1 wherein said encryption is generated with use of a password removal transform.

6. The method of claim 5 further comprising the steps of:
generating a proof that said encryption has been generated with use of a password removal transform;
communicating said proof to said plurality of servers.

7. The method of claim 6 wherein said proof comprises a non-interactive zero knowledge proof.

8. The method of claim 1 wherein said plurality of servers consists of n servers, and wherein said step of communicating the generated encryption communicates said generated encryption to a number k of servers, where k<n, said k servers being sufficient to authenticate said password.

9. A method for performing password authentication between a client and a plurality of servers, the client having a password to be authenticated by the plurality of servers, each of the plurality of servers having a share of a secret key, the secret key having a public key associated therewith, the method performed by one of said servers and comprising the steps of:
receiving from said client an encryption using the public key, wherein the encryption has been generated based on the password, but wherein the generated encryption is mathematically independent of said password; and
verifying that said encryption has been generated based on the password.

10. The method of claim 9 wherein said encryption is a representation of a predetermined plaintext message.

11. The method of claim 9 wherein said encryption has been generated with use of a password removal transform, the method further comprising the step of receiving from said client a proof that said encryption has been generated with use of said password removal transform, and wherein said step of verifying that said encryption has been generated based on the password comprises verifying said proof that said encryption has been generated with use of said password removal transform.

12. The method of claim 11 wherein said proof comprises a non-interactive zero knowledge proof.

13. The method of claim 11 wherein said step of verifying that said encryption has been generated based on the password further comprises verifying that said encryption is a representation of a predetermined plaintext message.

14. The method of claim 13 wherein the predetermined plaintext message is “1”.

15. The method of claim 9 wherein said step of verifying that said encryption has been generated based on the password is based on password authentication information received from one or more servers other than the server performing the method.

16. The method of claim 15 wherein said plurality of servers consists of n servers, and wherein said step of verifying that said encryption has been generated based on the password is based on password authentication information received from a number k−1 of the servers other than the server performing the method, where k<n.

17. A method for performing password authentication between a client and a plurality of servers, the client having a password to be authenticated by the plurality of servers, each of the plurality of servers having a share of a secret key, the secret key having a public key associated therewith, the method performed by the client and comprising the steps of:
generating an encryption using the public key, wherein the generation of the encryption is based on the password; and
communicating the generated encryption to the plurality of servers, wherein said plurality of servers consists of n servers, and wherein said step of communicating the generated encryption communicates said generated encryption to a number k of servers, where k<n, said k servers being sufficient to authenticate said password.

18. The method of claim 17 wherein the generated encryption is mathematically independent of the password and wherein said encryption is generated based on an ElGamal ciphertext encryption of a function of said password.

19. The method of claim 17 wherein the generated encryption is mathematically independent of the password and wherein said encryption is a representation of a predetermined plaintext message.

20. The method of claim 19 wherein said predetermined plaintext message is “1”.

21. The method of claim 17 wherein the generated encryption is mathematically independent of the password and wherein said encryption is generated with use of a password removal transform.

22. The method of claim 21 further comprising the steps of:
generating a proof that said encryption has been generated with use of a password removal transform;
communicating said proof to said plurality of servers.

23. The method of claim 22 wherein said proof comprises a non-interactive zero knowledge proof.

24. A method for performing password authentication between a client and a plurality of servers, the client having a password to be authenticated by the plurality of servers, each of the plurality of servers having a share of a secret key, the secret key having a public key associated therewith, the method performed by one of said servers and comprising the steps of:
receiving from said client an encryption using the public key, wherein the encryption has been generated based on the password; and
verifying that said encryption has been generated based on the password, wherein said plurality of servers consists of n servers, and wherein said step of verifying that said encryption has been generated based on the password is based on password authentication information received from a number k−1 of the servers other than the server performing the method, where k<n.

25. The method of claim 24 wherein the generated encryption is mathematically independent of said password and wherein said encryption is a representation of a predetermined plaintext message.

26. The method of claim 24 wherein the generated encryption is mathematically independent of said password and wherein said encryption has been generated with use of a password removal transform, the method further comprising the step of receiving from said client a proof that said encryption has been generated with use of said password removal transform, and wherein said step of verifying that said encryption has been generated based on the password comprises verifying said proof that said encryption has been generated with use of said password removal transform.

27. The method of claim 26 wherein said proof comprises a non-interactive zero knowledge proof.

28. The method of claim 26 wherein said step of verifying that said encryption has been generated based on the password further comprises verifying that said encryption is a representation of a predetermined plaintext message.

29. The method of claim 28 wherein the predetermined plaintext message is “1”.

30. The method of claim 24 wherein said step of verifying that said encryption has been generated based on the password is based on password authentication information received from one or more servers other than the server performing the method.
